(19) United States
(12) Patent Application Publication
(10) Pub. No.: US 2007/0156723 A1
(43) Pub. Date: Jul. 5, 2007

(54) Method and arrangement for reinterpreting user input in a mobile device

(75) Inventor: Johannes Vaananen, Oulu (FI)

Correspondence Address: COHEN, PONTANI, LIEBERMAN & PAVANE, 551 FIFTH AVENUE, SUITE 1210, NEW YORK, NY, 10176, US

(73) Assignee: Myorigo,S.a.r.L., Luxembourg (LU)

(21) Appl. No.: 11/593,653

(22) Filed: Nov. 6, 2006

Related U.S. Application Data
(63) Continuation of application No. PCT/FI05/50141, filed on May 2, 2005.

(30) Foreign Application Priority Data
May 7, 2004 (FI) 20045168

(51) Int. Cl. G06F 7/00

(52) U.S. Cl. 707/100

(57) ABSTRACT

The invention relates to a method and means for reinterpreting user input in a mobile device. In particular, the invention relates to a method and means for reinterpreting user input given during scrolling or browsing of data in a mobile device. Typically at very high scrolling speeds, or in motion guided devices, it is difficult for users to select data items from the data they scroll, as effects such as latency in reaction and hand eye coordination take effect. The invention features a method for associating a user selection with a data item while browsing data, comprising following steps: browsing history is stored, at least one data item is selected upon user input by a cursor and the data item or a group of data items selected by the user is determined based on the browsing history. The methods and arrangements of the invention allow the intended user selections to be resolved from selections that are made at high scrolling speeds or during motion guiding and typically contain error, and therefore allows the user to both scroll data fast and manipulate it easily and intuitively during scrolling or browsing.

### CROSS-REFERENCE TO RELATED APPLICATION

This is a continuation of International Application No. PCT/FI2005/050141 filed May 2, 2005.

### BACKGROUND OF THE INVENTION

1. Field of the Invention

The invention relates generally to a method and means for reinterpreting user input in a mobile device. In particular, the invention relates to a method and means for reinterpreting user input given during scrolling or browsing of data in a mobile device.

2. Description of the Related Art

The variety of data that mobile devices are used to access is growing rapidly. This sets new demands for mobile devices, and thus bigger screens and more ergonomic controls are appearing in mobile stations everyday. When a mobile station is used to browse large amounts of data, the ease and speed of scrolling are essential attributes of a mobile station.

For the sake of clarity, the following definitions are used in this application and defined explicitly here:

“Intended user selection”, “intended selection” this is the selection that the user intended to make and then embarked upon giving the input to the device.

“Perceived user selection”, “perceived selection” this is the selection that would get chosen by the moving cursor at the time the user input reaches the device.

“User input detection software”, a software used to detect the actual physical user input given by the user “as is”, i.e. the perceived selection.

“User input deduction software”, a software used to deduce the intended user selection from the perceived selection and other data, obtainable from for example browsing history.

The state of the art features several publications that highlight technologies that are used to make data browsing more user-friendly and faster. FIG. 1 presents a known method for a more intuitive cursor, used for scrolling or browsing of data that can be found from U.S. Pat. No. 6,259,432 B1. In this method an isosceles triangle appears near the cursor that signifies the direction of scrolling, and the number of triangles signifies the scrolling speed. By showing parameters relating to the scrolling the user is able to capture the scrolling process more intuitively.

FIG. 2 exhibits another method for making data scrolling more user friendly on a mobile device, which can be found from EP 0880091A3. In this method the data items 210, 220 that are displayed to the user are arranged on the surface of an imaginary cylinder 200 that is rotated in order to scroll the display. Apparently, this improves the speed and intuitive use of scrolling.

The known methods have significant deficiencies. When the user is browsing data at a high speed, it is very difficult for him to select data items during scrolling. Speed and ease of scrolling or making the user aware of the scrolling speed do not remove the fact that it is very difficult for the user to resolve and select data items when they are moving fast on the display.

### SUMMARY OF THE INVENTION

The present invention is directed towards a system and a method for effectively and intuitively selecting data items from data that is being scrolled even at a high speed. A further object of the invention is to present a system and a method for effectively allowing the user to make manipulation operations on these selected data items.

According to one aspect of the invention, the user browses data on mobile device and the browsing history of the user, device or session is stored to the memory of the device. During scrolling a data item is selected upon a user input, such as a press of button or turn of a switch. However, as the browsing speed effectively causes a discrepancy between the intended user selection and the real location of the cursor at the time of detection of the user input, i.e. the perceived selection, the data item selected by the user is determined based on the browsing history. In some preferable cases the determination is based on the extrapolated location of the cursor back in time when the user initiated the selection, user latency being accounted for. This way the intended user selection may be derived.

According to another aspect of the invention, the user browses data on the mobile device by motion guidance, i.e. the data is scrolled on the display by the user turning the device around some axis or by moving it back and forth. When the user presses e.g. a button to make a data item selection, the press of the button and related motion by the user typically alters the state of motion of the device and thus the position of the cursor as well. This will result in a discrepancy between the perceived and intended user selection that the invention can advantageously account for by considering the browsing history of the cursor and the device.

The invention allows the intended user selections to be resolved from selections that are made at high scrolling speeds and typically contain error, and therefore allows the user to both scroll data fast and manipulate it easily and intuitively during scrolling.

Some or all of the aforementioned advantages of the invention are accrued by determining the real user selection on the basis of browsing history and also other criteria, such as location of the cursor in immediate browsing history, inherent latency of the user, browsing speed, history of browsing speed and/or history of user latency.

A method for associating a user selection with a data item while browsing data is characterised by the following steps,

user browses data,

browsing history is stored,

at least one data item is selected upon user input by a cursor, the perceived selection,

the intended selection of a data item or a group of data items by the user is determined based on the browsing history and the said perceived selection.

A wireless device for displaying data in accordance with the invention comprising a memory and arranged to associate a user selection with a data item while browsing data is characterized in that,

user is arranged with the opportunity to browse data,

browsing history is arranged to be stored to the memory of the device,

at least one data item is selected upon user input by a cursor, the perceived selection,

the intended selection of a data item or a group of data items by the user is determined based on the browsing history and the said perceived selection.

A memory unit in accordance with the invention, comprising at least one software program product, arranged to associate a user selection with a data item while browsing data is characterized in that,

browsing history is arranged to be recorded by the browsing history software,

at least one data item selected upon user input by a cursor in arranged to be detected by the input detection software, the perceived selection,

the intended selection of a data item or a group of data items by the user is determined based on the browsing history and the said perceived selection by the input deduction software.

In addition and with reference to the aforementioned advantage accruing embodiments, the best mode of the invention is considered to be a method and a device executing the same where the position of the cursor that is used both for scrolling and data item selection is extrapolated to the location where the user first intended the selection of a data item with the cursor back in time, and this data item is determined as selected. This best mode is especially applicable in motion controlled mobile devices.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 depicts a prior art display cursor implementation;

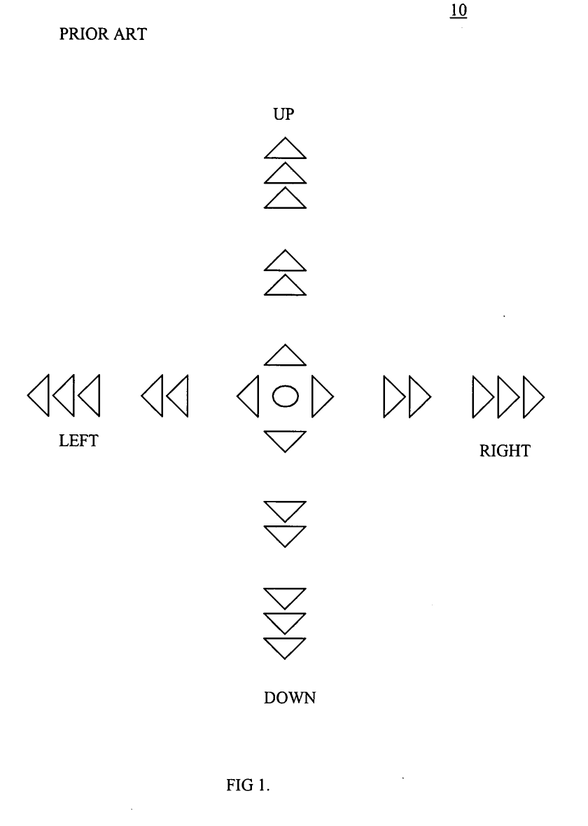

FIG. 2 depicts a prior art display scrolling arrangement;

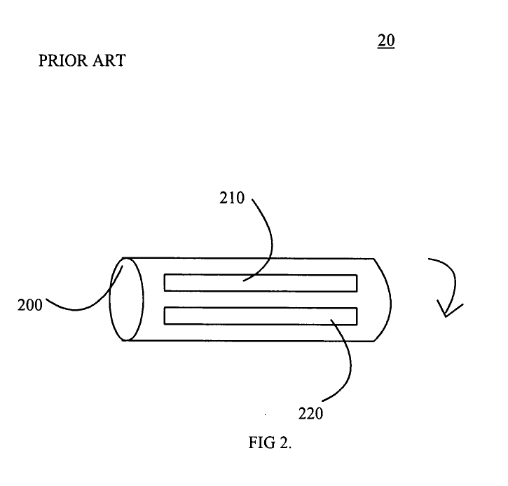

FIG. 3 demonstrates a generalized embodiment of the method of the invention 30 as a flow diagram;

FIG. 4 demonstrates a more elaborate embodiment of the method of the invention 40 as a flow diagram;

FIG. 5 demonstrates a more elaborate embodiment of the method of the invention 50 incorporating manipulation operations of the determined data item as a flow diagram;

FIG. 6 demonstrates an embodiment of the mobile station 60 in accordance with the invention;

FIG. 7 demonstrates one exemplary use scenario 70 of the mobile station in accordance with the invention; and

FIG. 8 demonstrates one exemplary memory unit 80 and associated functional software in accordance with the invention as a block diagram.

### DETAILED DESCRIPTION OF THE PRESENTLY PREFERRED EMBODIMENTS

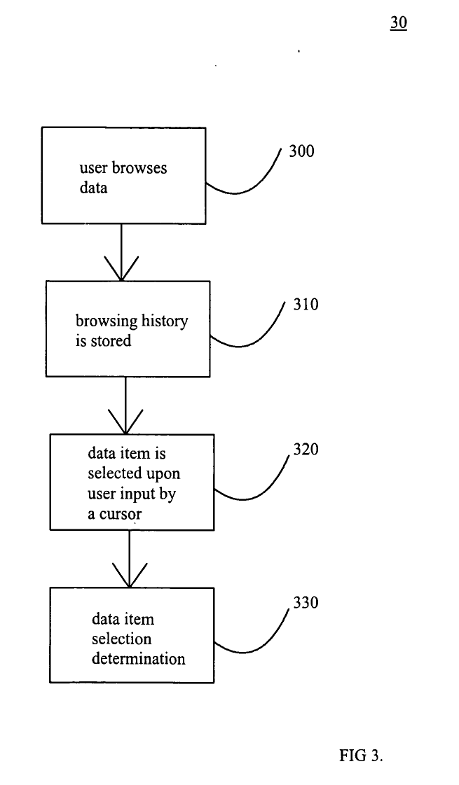

FIG. 3 exhibits an inventive method 30, where in phase 300 the user simply browses the data on the mobile device. The user may browse data on the mobile device in a multitude of ways, by a joystick, with a touch pad or a keyboard or by motion controlling the device by tilting the device or moving it back and forth so that data is scrolled in response to the state of motion or position of the device. In phase 310 the browsing history of the user, device or session is stored to the memory of the device, or to a network server to which the mobile device may be connected. The browsing history data may be collected by the device all the time continuously, upon a user selection, on intervals, or in dedicated sessions. In some embodiments the device produces dedicated browsing history files that can be distributed and analysed with dedicated software.

In phase 320 a data item from the display that may be scrolled is selected by the cursor upon user input, which may be a press of a button, turn of a switch, an audible and recognised command, or any other form of user input. In some embodiments the data item may be text, characters, an image, a hyperlink, Internet-address, directory information, telephone number, page in an electronic document and/or a file shortcut or a file.

In phase 330 the data item selection of the user is determined, i.e. the real intended choice of the user is determined based on the browsing history of the device, user, or session. In order for this determination to be successful, there typically needs to be an extensive enough browsing history. The data that is collected must typically be statistically significant and it must be fresh enough to be applicable at the time the determination is made out. In a way, the user teaches the device to take into account his individual browsing characteristics while making determinations of intended selections from the perceived selections. Browsing history itself typically comprises a log of the data that has been browsed before, such as: type of data, access time of data, access mode of data, cursor path along browsed data, cursor speed, user's reaction time, and/or latency of the user or the device or applications used in the device to respond to inputs.

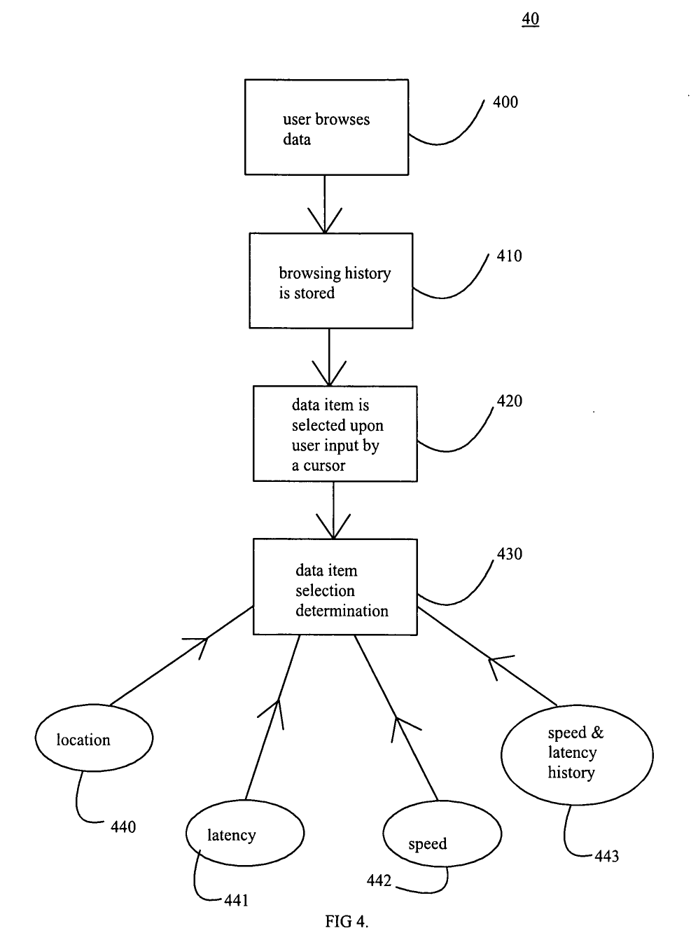

In FIG. 4 phases 400, 410, 420 are relatively similar to the phases 300, 310 and 320 of the earlier FIG. 3. However, the data item selection determination is more elaborate in this exemplary embodiment. In some embodiments not all aspects of the user's data browsing behaviour are recorded to the browsing history. It is also possible to bring relevant data into consideration outside the recorded browsing history. For example in method 40 the cursor location 440, latency of the user or device 441, speed of browsing 442 and/or speed and latency history are extracted elsewhere from the device or the user. This may be done by similar statistical analysis to the collection of browsing history or as direct user input, which may be extracted from user settings, for example. Likewise general statistical data applicable to larger populations may be used to define some parameters used in the determination.

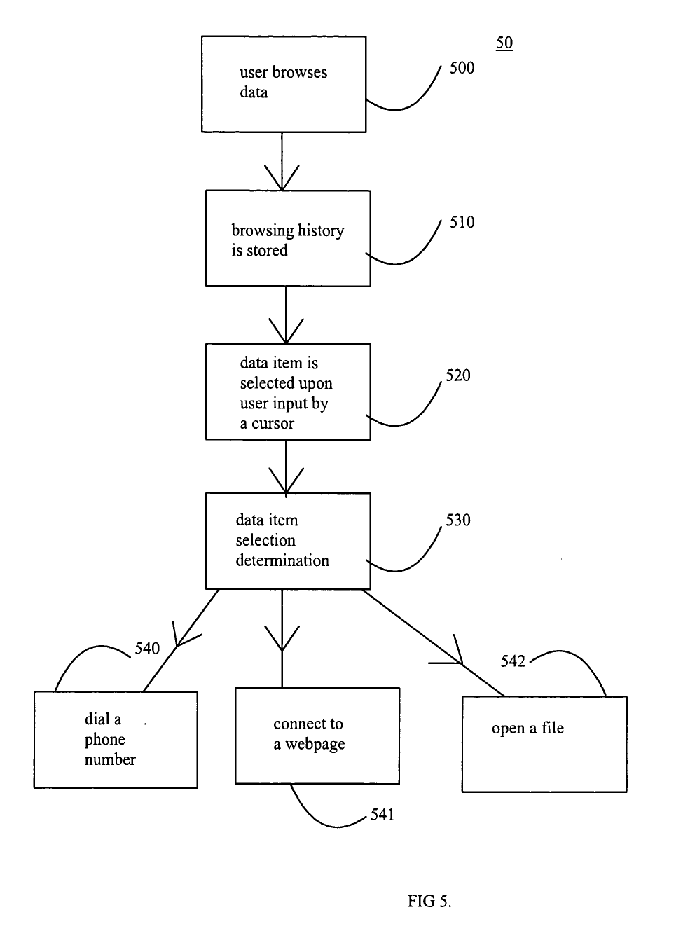

In FIG. 5 the initial phases 500, 510, 520 are similar to the earlier phases of 300, 310, 320 and 400, 410 and 420, respectively. In phase 530 the intended user input is determined based on principles outlined in phases 330, 430, but upon the determined input consequential action may be performed. For example, in some embodiments if the user intended to click the cursor when it was on top of a phone number, this phone number may now be dialled, phase 540. Likewise, if the user was intending to click the cursor on top of a URL address, the mobile station may now connect to the webpage defined by the URL, phase 541. If the user is browsing a file management system, for example, and was intending to click on a file icon in pursuit of opening the file, the file may be opened in phase 542 by relevant software.

It is clear that any data item defining any command or further action may either be the perceived or intended data item to be selected. In addition to opening a file, dialling a phone number or connecting to a web page, the further action may also be, for example, the sending of an electronic message, such as a cookie, email or SMS, or any other function.

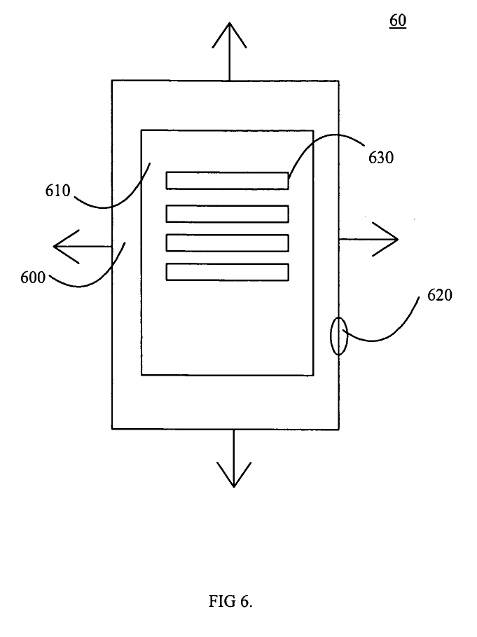

FIG. 6 presents an exemplary mobile station 60 in accordance with the invention. The display 610 is preferably relatively large in proportion to the device and comprises a multitude of data items that can be scrolled, for example 630. The cursor and the area displayed to the user can be scrolled with a variety of methods, for example with a joystick, touch pad, or by tilting and/or moving the device itself, as in this embodiment 60. Once the mobile station is tilted to a direction as indicated by the arrows, the display is scrolled either to this direction or the opposite, depending on the configuration of the device.

The mobile station 600 is also equipped with a button for making the data item selection 620. Quite clearly it is also possible to arrange the data item selections to be made by other means, such as a joystick, touch pad or the like. The pressing of button 620, or data selection by other means, also typically causes a change in the state of motion or position of the mobile station 600, however small, and thus the selection process itself can interfere with the position of the cursor in this motion guided device.

The mobile station may be a GSM, H323, HTTP, GSM data, IP-RAN, UMTS, WAP, Teldesic, Inmarsat, Iridium, GPRS, CDMA data, WCDMA data, HTTP, SMS, MMS, email LAN, TCP/IP, imode, Globalstar and/or WLAN compliant mobile station in some embodiments.

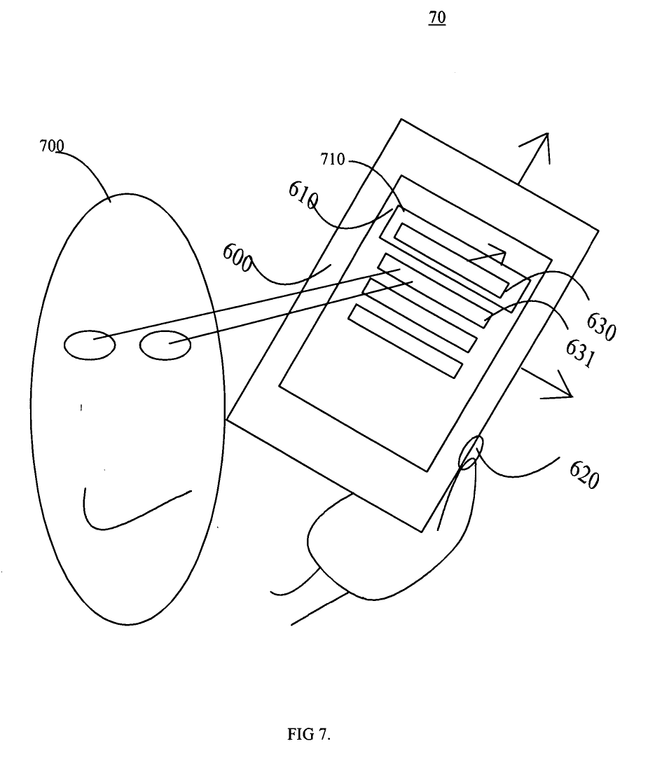

FIG. 7 presents one exemplary use scenario of the device and method of the invention. In this use scenario the user 700 scrolls the data on the display 610 fast by tilting the device, and the data items 630 and 31 traverse across the display to the direction of the tilt as indicated by the arrow at a remarkable speed. The user sees the data item 631 and decides to select it for further action. He presses the button 620 in order to commit this user input. However, due to the high speed of scrolling and impact of the press of the button 620 the cursor 710 has already passed to the data item 630, which is perceived as the user selection. Now, in accordance with the invention the browsing history may be used to determine the intended user selection. From the browsing history, the recent path of the cursor, its speed and the scrolling speed of the display and the latency of the user are available. Based on this data, the device may deduce that the intended user selection was indeed 631, and not 630, and proceed accordingly.

In some preferable embodiments, there is also a ‘freeze’ option for stalling the cursor to a fixed location upon a dedicated user input for a predefined time or a pixel count.

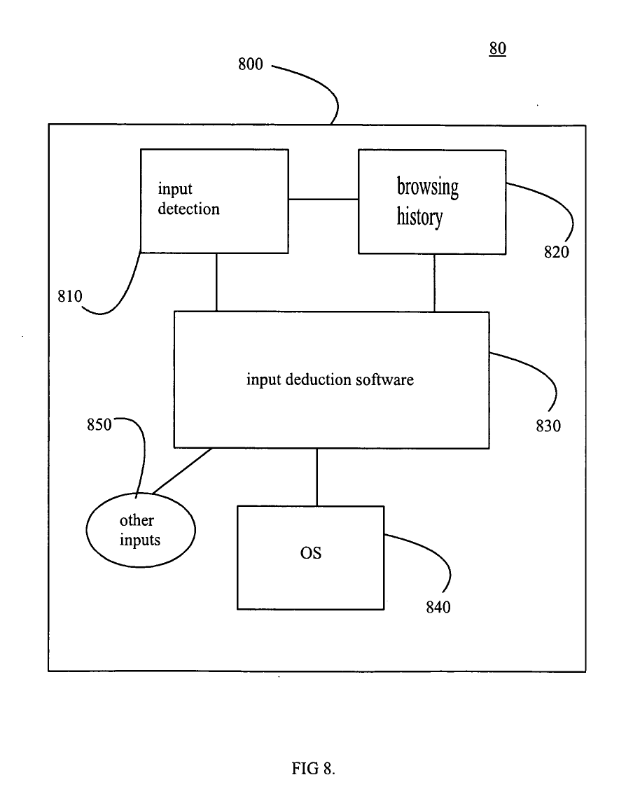

FIG. 8 presents an embodiment of the memory unit 800 comprising functional software arranged to technically implement the method of the invention. The input detection software 810 is designed to detect the user input in the first place, i.e. the press of the button, the turn of a switch or a joystick or the like input means. The input detection software typically comprises device drivers, such as keyboard device drivers, or other peripheral or user input device drivers.

The browsing history software 820 is arranged to collect and manage the browsing history data which may include a log of the data that has been browsed before, such as: type of data, access time of data, access mode of data, cursor path along browsed data, cursor speed, user's reaction time, and/or latency of the user or the device or applications used in the device to respond to inputs. In some embodiments the browsing history software 820 stores the browsing history data to a dedicated file system or a database.

Both the browsing history software 820 and the user input detection software 810 are connected to the user input deduction software 830. Based on the perceived user input provided by the input detection software 810 and the data provided by the browsing history software 820 the user input deduction software 830 is arranged to deduce the intended user input.

The user input deduction software 830 may accept other input data 850 for deducing the intended user input from elsewhere in the device or memory unit system, or from the operating system 840 of the device. Other input data that may originate outside the browsing history software and its data may include in some embodiments: the cursor location, latency of the user or device or software run on the device, speed of browsing and/or speed and latency history that are extracted elsewhere from the device or the user, by similar statistical analysis to the collection of browsing history or as direct user input, that may extracted from user settings, for example. Likewise general statistical data applicable to larger populations may be used as an external input 850 to the user input deduction software 830. In some embodiments the input deduction software 830 is aware of the state of motion of the device, or its position and can use this data to resolve between perceived and intended user selections.

The user input deduction software 830 is typically connected to the operating system 840 of the device, as in some embodiments are also the user input detection software 810 and the browsing history software 820. The operating system 840 typically obtains the intended user input from the user input deduction software 830 and may then initiate further actions related to the choice of this (intended) data item. The operating system may, for example, initiate a dialling of a phone number, a connection to an URL, web page, IP-address, FTP site or the like. Likewise the operating system may initiate an opening of a file or sending of an electronic message, such as a cookie, email, SMS or the like based on further action defined for the choice of the intended user input provided by the user input deduction software.

The invention has been explained above with reference to the aforementioned embodiments and several commercial and industrial advantages have been demonstrated. The methods and arrangements of the invention allow the intended user selections to be resolved from selections that are made at high scrolling speeds and typically contain error, and therefore allows the user to both scroll data fast and manipulate it easily and intuitively during scrolling or browsing. The invention is especially advantageous when applied to a new breed of mobile devices, motion guided mobile devices, where the data item selections cause an inherent disturbance in the state of motion or the position of the mobile device.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for associating a user selection with a data item while browsing data, characterized by the steps of,
user browses data,
browsing history is stored,
at least one data item is selected upon user input by a cursor, the perceived selection,
the intended selection of a data item or a group of data items by the user is determined based on the browsing history and the said perceived selection.

2. The method as claimed in claim 1, characterized in that the user browses data on the mobile station with a joystick, mouse, touch pad, keyboard or by motion guiding the mobile station.

3. The method as claimed in claim 1, characterized in that the browsing history comprises a log of the data that has been browsed before, such as: type of data, access time of data, access mode of data, cursor path along browsed data, cursor speed, user's reaction time, and/or latency of the user or the device or applications used in the device to respond to inputs.

4. The method as claimed in claim 1, characterized in that the determination of the selection of at least one data item is based on the location of the cursor in immediate browsing history, inherent latency of user, browsing speed, history of browsing speeds, history of user latency, state of motion of the device and/or position of the device.

5. The method as claimed in claim 1, characterized in that the location of the cursor is extrapolated to the location where the user first perceived the selection of the data item.

6. The method as claimed in claim 1, characterized in that at least one data item contains text, characters, an image, a hyperlink, Internet-address, directory information, telephone number, page in an electronic document and/or a file shortcut or a file.

7. The method as claimed in claim 1, characterized in that the selection of at least one data item leads to browsing of another restricted set of data associated with the selected data item.

8. The method as claimed in claim 1, characterized in that the selection of at least one data item leads to dialing a phone number, connecting to a web page, sending of an electronic message and/or opening of a file.

9. The method as claimed in claim 1, characterized in that upon at least one user input cursor position is held steady for a certain period of time and/or for a movement smaller than a certain pixel count.

10. A wireless device for displaying data, comprising a memory and arranged to associate a user selection with a data item while browsing data, characterized in that,
user is arranged with the opportunity to browse data with the wireless device,
browsing history is arranged to be stored to the memory of the device,
at least one data item is selected upon user input by a cursor, the perceived selection,
the intended selection of a data item or a group of data items by the user is determined based on the browsing history and the said perceived selection.

11. The device as claimed in claim 10, characterized in that the user browses data on the mobile station with a joystick, mouse, touch pad, keyboard or by motion guiding the mobile station.

12. The method as claimed in claim 10, characterized in that the browsing history comprises a log of the data that has been browsed before, such as: type of data, access time of data, access mode of data, cursor path along browsed data, cursor speed, user's reaction time, and/or latency of the user or the device or applications used in the device to respond to inputs.

13. A wireless device as claimed in claim 10, characterized in that the determination of the selection of at least one data item is arranged to be based on the location of the cursor in immediate browsing history, inherent latency of user, browsing speed, history of browsing speeds, history of user latency, state of motion of the device and/or position of the device.

14. The wireless device as claimed in claim 10, characterized in that the location of the cursor is extrapolated to the location where the user first perceived the selection of the data item.

15. The wireless device as claimed in claim 10, characterized in that at least one data item contains text, characters, an image, a hyperlink, Internet-address, directory information, telephone number, page in an electronic document and/or a file shortcut or a file.

16. The wireless device as claimed in claim 10, characterized in that the selection of at least one data item is arranged to lead to browsing of another restricted set of data associated with the selected data item.

17. The wireless device as claimed in claim 10, characterized in that the selection of at least one data item is arranged to lead to dialing a phone number, connecting to a web page, sending of an electronic message and/or opening of a file.

18. The wireless device as claimed in claim 10, characterized in that upon at least one user input cursor position is arranged to be held steady for a certain period of time and/or for a movement smaller than a certain pixel count.

19. The wireless device as claimed in claim 10, characterized in that the wireless device is a GSM-, H323-, HTTP-, GSM-data, IP-RAN-, UMTS-, WAP-, Teldesic-, Inmarsat-, Iridium-, GPRS-, CDMA-data-, WCDMA-data-, HTTP-, SMS-, MMS-, email- LAN-, TCP/IP-, imode-, Globalstar- and/or WLAN- compliant mobile station.

20. A memory unit, comprising at least one software program product, arranged to associate a user selection with a data item while browsing data, characterized in that
browsing history is arranged to be recorded by the browsing history software,
at least one data item selected upon user input by a cursor in arranged to be detected by the input detection software, the perceived selection,
the intended selection of a data item or a group of data items by the user is determined based on the browsing history and the said perceived selection by the input deduction software.

21. The memory unit as claimed in claim 20, characterized in that the said software is arranged to provide the user with an opportunity to browse data on the mobile station with a joystick, mouse, touch pad, keyboard or by motion guiding the mobile station.

22. The memory unit as claimed in claim 20, characterized in that the browsing history software is arranged to collect a log of the data that has been browsed before, such as: type of data, access time of data, access mode of data, cursor path along browsed data, cursor speed, user's reaction time, and/or latency of the user or the device or applications used in the device to respond to inputs.

23. The memory unit as claimed in claim 20, characterized in that the said at least one data item is arranged to be selected based on the location of the cursor in immediate browsing history, inherent latency of user, browsing speed, history of browsing speeds, history of user latency, state of motion of the device and/or position of the device.

24. The memory unit as claimed in claim 20, characterized in that the location of the cursor is extrapolated to the location where the user first perceived the selection of the data item.

25. The memory unit as claimed in claim 20, characterized in that at least one data item contains text, characters, an image, a hyperlink, Internet address, directory information, telephone number, page in an electronic document and/or a file shortcut or a file.

26. The memory unit as claimed in claim 20, characterized in that the selection of at least one data item is arranged to lead to browsing of another restricted set of data associated with the selected data item.

27. The memory unit as claimed in claim 20, characterized in that the selection of at least one data item is arranged to lead to dialing a phone number, connecting to a web page, sending of an electronic message and/or opening of a file.

28. The memory unit as claimed in claim 20, characterized in that upon at least one user input cursor position is arranged to be held steady for a certain period of time and/or for a movement smaller than a certain pixel count.

29. The memory unit as claimed in claim 20, characterized in that the memory unit is arranged to be installed in a GSM, H323, HTTP, GSM data, IP-RAN, UMTS, WAP, Teldesic, Inmarsat, Iridium, GPRS, CDMA data, WCDMA data, HTTP, SMS, MMS, email LAN, TCP/IP, imode, Globalstar and/or WLAN compliant mobile station.
